(19) United States
(12) Patent Application Publication
(10) Pub. No.: US 2007/0201861 A1
(43) Pub. Date: Aug. 30, 2007

(54) Imaging device

(76) Inventors: Betty A. Coulman, Corvallis, OR (US); Kevin E. Swier, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/363,364

(22) Filed: Feb. 27, 2006

(51) Int. Cl. G03B 17/00

(52) U.S. Cl. 396/420

(57) ABSTRACT

Example embodiments of an imaging device are illustrated and described.

### BACKGROUND

In some applications, an imaging device may be used in different locations. Moving the imaging device between the different locations may be cumbersome. Also, sometimes, a user may carry the imaging device in palms of the user's hands in moving the imaging device from one location to another. As such, it may be difficult for the user to carry other objects in the palms of their hands or to perform other functions with their hands while moving and/or supporting the imaging device.

### BRIEF DESCRIPTION OF THE DRAWINGS

FIG. 1 illustrates an example embodiment of an imaging device and an example embodiment of an associated mounting member.

FIG. 2 illustrates another example embodiment of an imaging device and an example embodiment of an associated mounting member.

FIG. 3 illustrates another example embodiment of an imaging device and an example embodiment of an associated mounting member.

FIG. 4 illustrates an example embodiment of an imaging device coupled to a user's hand.

FIG. 5 illustrates an example embodiment of an imaging device coupled to a user's hand adjacent a surface.

FIG. 6 illustrates an example embodiment of an imaging device coupled to a user's hand and to an example supply.

FIG. 7 illustrates an example embodiment of an imaging device on an example glove.

### DETAILED DESCRIPTION

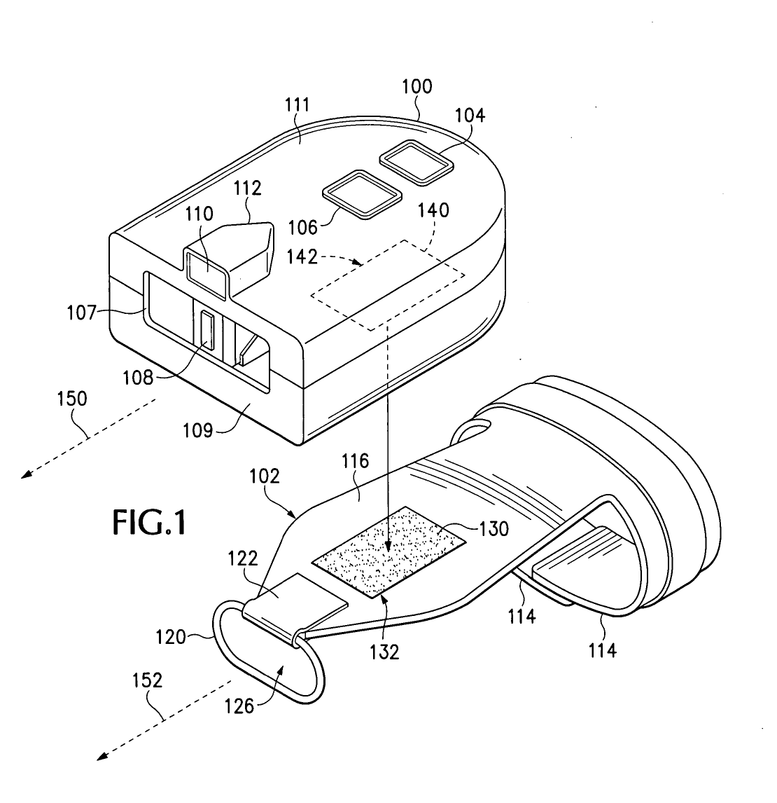

FIG. 1 illustrates an example embodiment of a hand-mountable imaging device 100 and an associated mounting member 102. The imaging device 100 is shown as including input buttons 104, 106 for receiving input from a user. The input button 104 may be used, for example, to actuate the imaging device 100 to print. The input button 106 may be used, for example, to actuate the imaging device 100 to scan. In other embodiments, however, actuation of the imaging device may be accomplished via mechanical actuation, accelerometer-triggered actuation, voice activation, EM actuation, electronic actuation, or by another suitable actuation technique.

The imaging device 100 may include a printhead 108 for ejecting ink onto a medium. The printhead 108 may comprise a thermal inkjet print head in some embodiments. As shown, the printhead 108 is configured to print through an opening 107 formed in a front wall 109 of the imaging device 100. In other embodiments, other types of printheads may be alternatively employed. Additionally, suitable printing mechanisms other than printheads may be employed in some alternate embodiments. Moreover, in other embodiments, the printhead 108 may be disposed at locations other than adjacent the front wall 109. Further, in some other embodiments, the printhead 108 may be extendable toward the surface upon which printing is to occur. In some embodiments, the imaging device 100 may be configured to print or otherwise form tactile features on a surface, such as are used in Braille writing.

The imaging device 100 may also include an auxiliary mechanism 110. In some embodiments, the auxiliary mechanism 110 may comprise a scanner 110 for optically scanning information and storing the optically scanned information in a memory (not shown) disposed within the device 100. The auxiliary mechanism 110 is shown as being disposed in a raised window 112 of the imaging device 100, but may be positioned elsewhere on the device 100. In other embodiments, the auxiliary mechanism 110 may comprise one or more of the following: a proximity sensor, an image recognition device, a GPS receiver, a microphone, a speaker, a light source, a timer, a camera, an RF source, an RF receiver, an RFID sensor, a wireless transceiver, environmental conditions sensor, a memory, removable memory, OCR, a touch screen, a chemical sensor, or the like.

Moreover, while not illustrated in FIG. 1, the imaging device 100 may include a display on a top surface 111 of the imaging device 100. The display may be useful as a control panel for the imaging device, to display print job information, or to display information corresponding to data sent or received via the auxiliary mechanism 110. In other embodiments, the display may be useful for other purposes. Additionally, the display may be positioned at a location other than the top surface 111 pursuant to other embodiments.

Details regarding portable devices, including portable printers and portable scanners are illustrated and described in the following U.S. patent applications and U.S. patents, the disclosures of which are hereby incorporated by reference: U.S. Pat. No. 6,769,360; U.S. Pat. No. 6,846,119; U.S. Pat. No. 6,550,683; U.S. patent application Ser. No. 11/263456; U.S. patent application Ser. No. 11/208,475.

The mounting member 102 is configured to be secured to a hand of a user (not shown in FIG. 1). In particular, the mounting member 102 includes straps 114 for wrapping around a user's wrist, hand, fingers, and/or arm. The straps 114 may be integrally formed with a platform portion 116 of the mounting member 102. The ends of the straps 114 may be connected by buttons, snaps, hook and loop fabric fasteners, or by any other suitable fastener. The platform portion 116 of the mounting member 102 may be made of nylon, leather, polyester, rubber, vinyl, or other suitable woven or non-woven material or combination of materials. The mounting member 102, the imaging device, or both, may include padding and contouring for comfort.

The mounting member 102 is also shown as including a ring 120. The ring 120 is fastened to the platform portion 116 of the mounting member 102 by fastener 122. The fastener 122 may be attached to the platform portion 116 by an adhesive, by rivets, a clip, or by another suitable fastening technique. In other embodiments, the ring 120 may be formed integrally with the mounting member 102. The ring 120 is shown as being sized and positioned to permit one or more fingers of a user to pass through an interior 126 of the ring 120. The user's fingers, disposed within the interior 126 of the ring 120 may be used to provide support to the mounting member 102. In some embodiments, the ring 120 may be coupled to the device 100 such that the device 100 may be actuated via the ring 120. The ring 120 may, in some embodiments, be adjustable. Further, in other embodiments, the ring 120 may be directly attached to the device 100.

Hence, in some embodiments, the mounting member 102 may be maintained on a user with the straps 114 wrapped about the user's wrist, hand, fingers, or arm and one or more of the user's fingers disposed within the ring 126.

In some embodiments, the platform portion 116 is positioned adjacent to a back portion of a user's hand. The back portion of a user's hand is that portion of a user's hand generally opposite a palm portion of the user's hand. In other embodiments, the platform portion 116 may be positioned elsewhere.

The mounting member 102 is shown as including a fastener 130 on, or formed integrally with, the platform portion 116 of the mounting member. The fastener 130 is located at securing location 132. It is at the securing location 132 where the imaging device 100 attaches to the mounting member 102. The imaging device 100 and the mounting member 102, in some embodiments, may be formed integrally. In some embodiments, the imaging device 100 and may be secured to the mounting member 102 at multiple, discrete locations.

The imaging device 100 includes a securing location 142 (shown in dotted lines in FIG. 1). The securing location 142 is shown as a location on an outside, bottom surface of the imaging device 100. A fastener 140 (shown in dotted lines in FIG. 1) may be disposed on, or formed integrally with, the imaging device 100 at the securing location 142. In operation, the securing locations 132, 142 are positioned adjacent each other. Moreover, in operation, the fasteners 130, 140 contact and connect with each other to secure the imaging device 100 on the mounting member 102.

The position of the imaging device 100 relative to the user's hand may vary. In some embodiments, the position of the imaging device 100 relative to the user's hand is adjustable and can be varied. Additionally, the position of the imaging device 100 relative to the mounting member 102 may also vary.

In some embodiments, the fasteners 130, 140 comprise hook and loop type fasteners. In other embodiments, the fasteners 130, 140 may comprise snaps, buttons, rivets, or other suitable fastener. Some fasteners 130, 140, such as hook and loop type fasteners permit the imaging device 100 to be removably secured to the mounting member 100. As such, relative movement between the imaging device 100 and the mounting member 102 may be provided in some embodiments.

Alternatively, an adhesive may be positioned at one or both of the securing positions 132, 142 such that the imaging device 100 is secured to the mounting member 102 via adhesion. The adhesive may comprise glue, epoxy, or other suitable adhesive.

As shown in FIG. 1, the imaging device 100 includes a longitudinal axis 150. The mounting member 102 includes longitudinal axis 152. In some embodiments, the imaging device 100 may be positioned on the mounting device 102 such that the axis 150 is substantially parallel to the axis 152. That is, the imaging device 100 may be positioned on the mounting device 152 such that the axis 150 points in substantially the same direction as the axis 152. In other embodiments, the imaging device 100 may be positioned on the mounting device 102 such that the axis 150 and the axis 152 point in different directions. In a particular other example embodiment, the axis 150 and the axis 152 may point in substantially orthogonal or perpendicular directions. Moreover, in some embodiments, the relative orientations of the axes 150, 152 may be variable or otherwise adjustable.

In some embodiments, the imaging device 100 may be integrally formed with the mounting device 102.

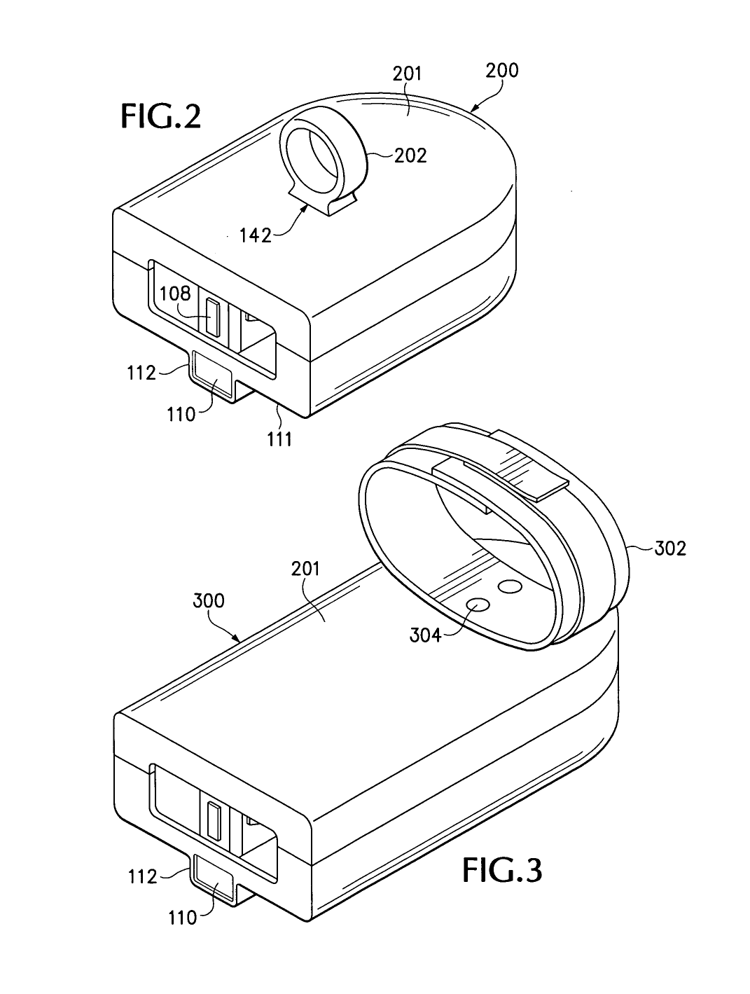

FIG. 2 illustrates an imaging device 200 in accordance with another example embodiment. The imaging device 200 is identical to the imaging device 100 described above and illustrated in FIG. 1, except as follows. A ring 202 is disposed at the securing location 142 at bottom surface 201 of the imaging device 200. The ring 202 is sized to accommodate insertion of a finger or fingers of a user. As such, the imaging device 200 may be supported by the finger or fingers of the user. In some example embodiments, at least a portion of the imaging device 200 is adjacent the back portion of a user's hand.

In some embodiments, the ring 202 comprises a portion of a user's garment, such as a portion of a user's shirt sleeve where an aperture is formed therein to permit passage of the user's finger or fingers through the aperture. As such, the device 100 need not be directly connected to the ring 202. Rather, the device 100 may be mounted on the user's garment in spaced relation to the ring 202. In some embodiments a point of attachment to the user's hand, in addition to the ring 202, may be provided.

FIG. 3 illustrates an imaging device 300 in accordance with another example embodiment. The imaging device 300 is identical to the imaging device 100 shown in FIG. 1, except as follows. The imaging device 300 includes a strap 302 coupled to a bottom surface 201. The strap 302 may be formed of a rigid or flexible material and may be secured to the bottom surface 201 by one or more fasteners 304. Alternatively, the strap 302 may be secured to the imaging device 300 using hook and loop type fasteners, an adhesive, or other suitable technique. The strap 302 may form a continuous, endless loop, in some embodiment. In other embodiments, such as the embodiment shown in FIG. 3, the strap 302 comprises ends that may be attached via buttons, snaps, hook and loop type fasteners, or by other suitable techniques. While the strap 302 is generally shown as being positioned toward a rear portion of the surface 201, the strap 302 may alternately be positioned elsewhere on the imaging device 300.

In some embodiments the strap 302 may be coupled or attached to other support features, such as a ring or other suitable support feature. In some embodiments, the strap 302 may comprise a portion of a garment, such as a cuff portion of a user's shirt.

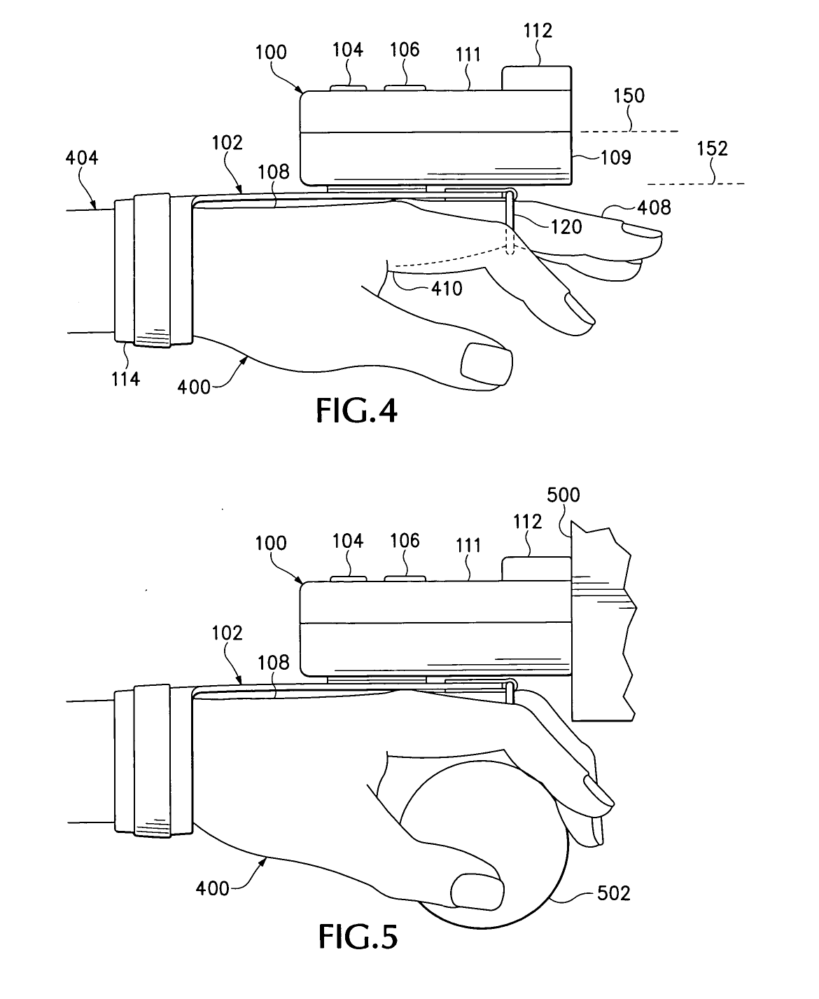

FIGS. 4 and 5 illustrate the imaging device 100 mounted on the mounting member 102. The mounting member 102 is shown as being positioned on a user's hand 400. The straps 114 are shown as being positioned about a wrist portion of the user. The straps 114, in other embodiments, may be positioned elsewhere, such as about a hand or finger(s) of the user. The ring 120 is shown as being positioned around one or more fingers 408 of the user. The axis 150 is shown as being parallel to and pointing in the same direction as the axis 152. In this configuration, the imaging device 100 is secured to a back portion 408 of the user's hand 400. As such, the palm portion 410 of the user's hand 400, as well as the fingers 408 may be used for purposes other than gripping the imaging device 100.

FIG. 5 illustrates the imaging device 100 printing on surface 500, scanning information on surface 500, or both, while mounted on a back portion of a user's hand. The imaging device 100 may be positioned adjacent or in contact with the surface 500 to print on or scan the surface 500. Text, images, or both, may be printed by the device 100 onto the surface 500. The printing on the surface 500 may, in some embodiments, be accomplished by ejecting ink or other fluid from the printhead 108. Other suitable printing techniques may alternatively be employed. The printing may also include formation of tactile features, such as used in Braille printing. Additionally, or alternatively, the imaging device 100 may be positioned adjacent or in contact with the surface 500 to scan information on the surface 500. The scanning may be accomplished by the auxiliary mechanism 110 configured as a scanner.

In addition, FIG. 5 illustrates that the fingers 408 and inside portion of the user's hand 400 may be used for tasks other than gripping the imaging device 100 while the imaging device 100 is mounted on a back portion 408 of the user's hand. As shown in FIG. 5 as an example, the user's fingers grip the object 502 during operation of the imaging device 502.

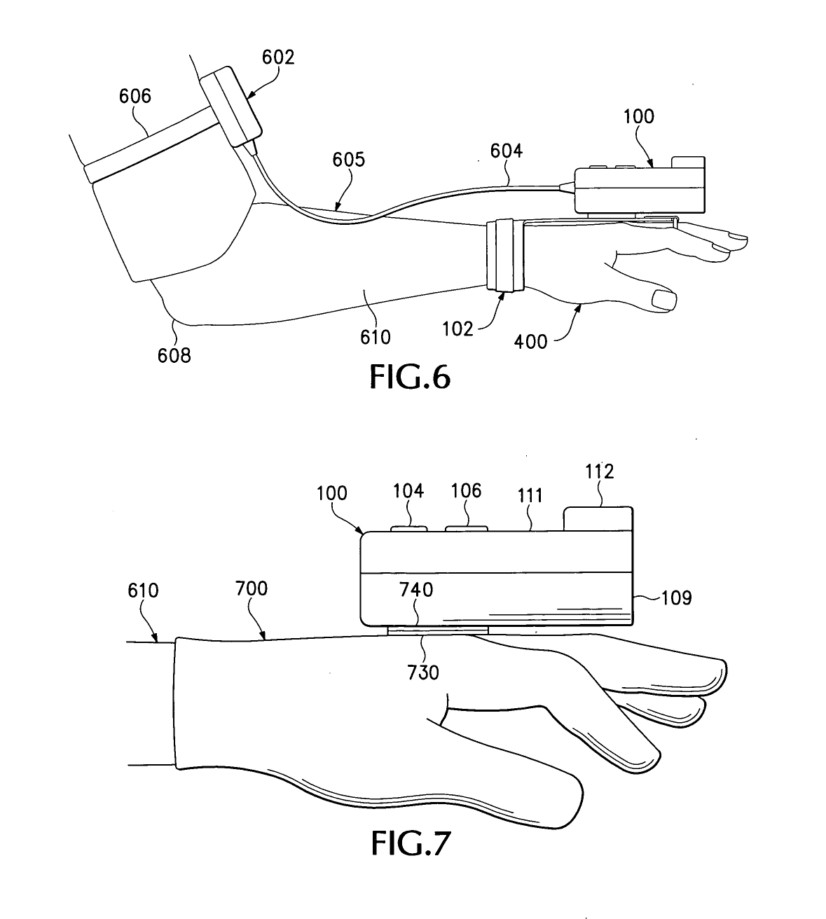

FIG. 6 illustrates an embodiment of the imaging device 100 and mounting member 102 that includes a supply 602 mounted to an arm 605 of the user. The arm of a user is that portion of the user that extends between the user's shoulder and wrist, including the shoulder and the wrist. As shown, the supply may be mounted to the arm 605 of the user by a strap 606 or by other suitable technique. The supply 602 is coupled to the imaging device 100 via supply line 604. Positioning the supply 602 away from the hand 400 permits the weight of the supply 602 to be carried by the arm 605, rather than the hand 400.

The supply 602 may supply power, ink, data, pressurized gas or other suitable content, or a combination of these, to the imaging device 100. As such, in embodiments where the supply 602 supplies power to the imaging device 100, the supply 602 may include one or more batteries. In embodiments where the supply 602 supplies ink to the imaging device 100, the supply 602 comprises one or more ink reservoirs. Further, in embodiments where the supply 602 supplies data to the imaging device 100, the supply includes a computer-readable medium, such as a memory device. Data may be transferred back and forth between the device 100 and the supply 602. The supply line 604 may include, in some example embodiments, a fiber optic cable or other suitable data channel.

By mounting the supply 602 to an arm portion of a user and above the wrist of the user, the weight of the supply 602 may be substantially borne by the arm of the user to reduce the weight supported by the user's hand. In yet other embodiments, the supply may be mounted elsewhere on the user, such as on the user's waist or back.

FIG. 7 illustrates the imaging device 100 mounted on a user's hand via glove 700, in accordance with an example embodiment. The glove 700 is shown as disposed on the user's hand and as covering the user's hand. The glove 700 is also shown as covering a portion of the user's wrist.

In other implementations, however, the glove 700 may cover only select portions of the user's hand. For example, in some embodiments, the glove 700 may be configured with openings (not shown) at the finger portions of the glove such that the user's bare fingers may protrude and be exposed through such openings. Hence, the glove 700, in some embodiments, may be fingerless.

Additionally, pursuant to other configurations, the glove 700 may not cover a significant portion of the user's wrist. Indeed, in some embodiments the glove 700 does not cover any portion of the user's wrist.

The glove 700 may be made of a nylon-based fabric, a polytetrafluoroethylene-based fabric, leather, a cotton-based fabric, or any other suitable fabric. In some embodiments, the glove 700 is substantially or at least partially waterproof. Pursuant to some embodiments, the glove 700 may also include other, task-specific, attributes such as a gripping surface, body protection, anti-static, moisture-wicking away from body, warmth, washability, and the like.

The imaging device 100 is shown as secured to the glove 700 by fasteners 730, 740. In other embodiments, a suitable adhesive may be used in lieu of the fasteners 730, 740. The fasteners 730, 740 may comprise any suitable fastener, including hook and loop type fasteners, snaps, buttons, or the like.

Although the present disclosure has been described with reference to example embodiments, workers skilled in the art will recognize that changes may be made in form and detail without departing from the spirit and scope of the claimed subject matter. For example, although different example embodiments may have been described as including one or more features providing one or more benefits, it is contemplated that the described features may be interchanged with one another or alternatively be combined with one another in the described example embodiments or in other alternative embodiments. The present disclosure described with reference to the example embodiments and set forth in the following claims is manifestly intended to be as broad as possible. For example, unless specifically otherwise noted, the claims reciting a single particular element also encompass a plurality of such particular elements.

What is claimed is:

1. A device, comprising:
an imaging device configured to print;
a member configured to secure the imaging device to a hand of a user.

2. The device of claim 1, wherein the member is removably attached to the imaging device.

3. The device of claim 1, wherein the member is configured to be positioned about a wrist portion of the user.

4. The device of claim 1, wherein the member is configured to be positioned about one or more fingers of the user.

5. The device of claim 1, wherein the member is configured to be positioned about a hand of the user.

6. The device of claim 1, wherein the member comprises a ring.

7. The device of claim 1, wherein the imaging device comprises an inkjet printhead.

8. The device of claim 1, wherein the imaging device comprises a scanner.

9. The device of claim 1, wherein the imaging device is mounted on a back portion of the hand of the user such that a palm portion of the hand of the user faces away from the imaging device.

10. The device of claim 1, wherein a longitudinal axis of the member and a longitudinal axis of the imaging device point in a common direction.

11. The device of claim 1, further comprising a supply configured to mount on a portion of an arm of the user, the portion of the arm of the user being above a wrist of the user.

12. The device of claim 1, further comprising a supply configured to mount on a portion of an arm of the user, the portion of the arm of the user being above an elbow of the user.

13. An apparatus, comprising:
a print mechanism;
means for mounting the print mechanism to a portion of the hand of a user.

14. A method, comprising:
mounting a mechanism to a hand of a user;
ejecting ink from the mechanism while the mechanism is mounted on the hand of the user.

15. The method of claim 14, wherein the ejecting further comprises ejecting ink from a printhead.

16. The method of claim 14, further comprising:
mounting a supply to the user;
coupling the supply to the mechanism via a supply line;
transferring at least one of ink, power, EM radiation, or data from the supply to the mechanism via the supply line.

17. The method of claim 14, further comprising:
mounting a supply to an arm of the user;
coupling the supply to the mechanism.

18. The method of claim 14, wherein the mechanism further comprises a scanner, the method further comprising scanning an image while the mechanism is mounted to the back portion of the hand of the user.

19. The method of claim 14, further comprising:
mounting a supply to an arm of the user, above a wrist portion of the arm;
coupling the supply to the mechanism.

20. The method of claim 19, wherein the supply comprises one or more batteries.
